(19) United States
(12) Patent Application Publication
(10) Pub. No.: US 2007/0212049 A1
(43) Pub. Date: Sep. 13, 2007

(54) Auto-focusing method and auto-focusing apparatus using the same

(75) Inventors: Serkan Guroglu, Suwon (KR); Sung Deuk Kim, Seoul (KR); Burhanettin Koc, Suwon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/714,882

(22) Filed: Mar. 7, 2007

(30) Foreign Application Priority Data
Mar. 7, 2006 (KR) 10-2006-0021410

(51) Int. Cl. G03B 13/00

(52) U.S. Cl. 396/127

(57) ABSTRACT

A auto-focusing method comprises setting a plurality of active windows composed of a central window and a plurality of peripheral windows surrounding the central window and allocating weights to the plurality of active windows so as to calculate an auto-focus value for each step; calculating a rate of change in auto-focus value between a previous step and a current step from the auto-focus value calculated for each step; comparing the calculated rate of change in auto-focus value with preset auto-focus reference values and then changing a step size in accordance with the comparison result; transferring a lens to a position corresponding to the changed step size; repeating the above processes from the setting of the plurality of active windows to the transferring of the lens until the auto-focus value of the previous step becomes larger than that of the current step and then determining whether the maximum auto-focus value is detected or not; and transferring the lens to a position corresponding to the maximum auto-focus value.

### CROSS-REFERENCE TO RELATED APPLICATIONS

This application claims the benefit of Korean Patent Application No. 10-2006-0021410 filed with the Korea Intellectual Property Office on Mar. 7, 2006, the disclosure of which is incorporated herein by reference.

### BACKGROUND OF THE INVENTION

1. Field of the Invention

The present invention relates to an auto-focusing method and an auto-focusing apparatus using the same, which can be applied to a camera module mounted on mobile terminals.

2. Description of the Related Art

Recently, as the information technology rapidly develops, complex mobile communication terminals to which various functions as well as a phone function are added are being required to be developed. Therefore, portable mobile communication terminals having a function of transmitting and receiving images and voices are implemented. As for the portable mobile communication terminal, there is provided a camera phone which is implemented by adding a digital camera function to a mobile communication terminal (mobile phone).

A general camera phone is composed of a camera module for photographing an image, a transmission module for transmitting voice and image of a user, and a reception module for receiving voice and image of the other party.

The camera module includes a lens sub system and an image processing sub system.

The lens sub system includes a lens section composed of a zoom lens and a focus lens, an actuator for driving the zoom lens or focus lens of the lens section, and an actuator driver.

The image processing sub system includes an image sensor and ISP, an auto-focusing digital signal processor and the like.

The lens sub system serves to adjust focus to an external sight to be photographed. Further, the lens sub system allows light (light source) to be incident on an image sensor, the light being incident on a specific region, of which the range is preset, from the external sight.

The image sensor of the image processing sub system is composed of photo cells in which electric charges are stored as light is incident during a specific absorption period. The image sensor converts the stored electric charges into digital values (pixel values) to output.

The ISP of the image processing sub system compresses the digital values with respect to acquired pixels and then performs image processing, such as scaling image enhancement, on the compressed digital values to transmit to a mobile phone body.

At this time, the lens sub system performs a focus adjusting operation in order to photograph a clear image. In this case, an auto-focusing apparatus provided in a general camera or digital camera is used as it is. The description thereof will be made as follows.

In general, once a user sets a composition with respect to an object to be photographed and then presses a release button, the auto-focusing apparatus of a general camera or digital camera automatically adjust focus such that photographing is performed.

Such an auto-focusing apparatus is divided into an active auto-focusing apparatus and a passive auto-focusing apparatus.

The active auto-focusing apparatus emits infrared rays or ultrasonic waves to an object and then detects light or wave reflected from the object so as to measure a distance from the object.

The passive auto-focusing apparatus having no light emitting section receives light emitted from an object by using a lens section and measures a distance from the object by using the brightness of the object.

Among image signals coming from an image sensor, the passive auto-focusing apparatus detects a high-pass frequency signal for each frame, the high-pass frequency signal being proportional to contrast. When a luminance signal passes through a high-pass filter, the high-pass frequency signal is obtained. The passive auto-focusing apparatus compares the obtained contrast with the contrast of the previous frame. Then, the passive auto-focusing apparatus moves a focus lens in a direction where the contrast increases and then stop the focus lens at a spot, of which the contrast is the greatest, such that focus is automatically adjusted.

In general, an auto-focusing camera module performs image-signal processing on an image received through a CCD (charge coupled device) or CMOS (complementary metal oxide semiconductor) sensor and then extracts a focus value in a picture unit to deliver to a CPU, the focus value being calculated through an edge passing through a high-pass filter (HPF). Based on the calculated focus value, the CPU determines a moving direction and distance of the focus lens and makes an instruction to the actuator driver. Accordingly, the actuator is driven to move the lens such that focus is automatically adjusted.

FIG. 1A is a diagram illustrating a window 101 within a picture 100. As shown in FIG. 1A, the central region of a screen is designated as the window 101. The reason is that most of users pay attention to the central portion of the screen when taking a photograph.

Further, the start and end positions of the window are transmitted from the auto-focusing digital signal processor such that the window 101 within the picture 100 is set. Output values from a high-pass filter at the window 101 are accumulated by an integrator.

The accumulated value (focus value) becomes a reference value for adjusting focus in the camera module. In the case of a still image, focus is adjusted by moving a lens. When the image is in complete focus, a focus value is high. When the image is not in focus, a focus value is low. Typically, the focus of a camera is adjusted by reference to the center of a screen to which most of users pay attention.

The algorithm for finding a focus value is performed by the CPU within the auto-focusing digital signal processor. The CPU determines which direction to move the lens and then drives the actuator by using the actuator driver.

FIG. 1B is a graph showing a focus value in accordance with a lens moving distance.

As shown in FIG. 1B, when focus is not adjusted even though the same image is input to a camera, a focus value is low as in a spot ‘A’. At this time, the moving direction of the lens is determined at a spot ‘B’, and the lens is moved in a ‘C’ direction where a focus value increases. When the focus value passes by a spot ‘E’ with the maximum focus value, the lens is transferred in a ‘D’ direction (reverse to the ‘C’ direction) and is fixed at the spot ‘E’ so as to find the maximum focus value.

In the related art, the focus value is calculated for each picture. That is because a value obtained by summing all the edge components of the window to which users pay attention is output for each picture.

Therefore, in order to search the maximum focus value in the related art, the following process is repeated. The focus values of pictures are respectively calculated, and the direction is determined in accordance with the calculated focus values such that the lens is moved in that direction.

In the related art, a lens moving range in the process of searching the maximum focus value is divided into a fine scanning region and a coarse scanning region such that different constant step sizes are applied to the respective regions.

In such a method, however, the step size changes only when the searching process is transited from the coarse scanning region to the fine scanning region. Therefore, a fine step size is inevitably applied to the coarse scanning region so as not to pass over a narrow peak region. Accordingly, a time required for searching the maximum focus value is lengthened, and power consumption increases.

Recently, as CMOS image sensors have an enhanced image quality, more and more CMOS image sensors having low power consumption are used in mobile phones, smart phones, and PDAs. Therefore, a time required for finding the maximum focus value, that is, an auto-focusing time is lengthened. The frame rate of the CMOS image sensor is as low as 30 per second, and users demand an image quality with high resolution. Therefore, the frame rate of the CMOS image sensor becomes much lower, and an auto-focusing time is significantly lengthened.

Further, in a curve having a flat peak region as shown in FIG. 2, an unnecessary searching process using a fine step size is repeated in the related art. Therefore, an auto-focusing time is lengthened, and the power consumption increases.

In the conventional passive auto-focusing method, it is highly likely that focus is adjusted to a background, not to an object. When there is a background with high contrast around an object, most of algorithms searches the maximum auto-focus value corresponding to the background. In order to prevent focus from being adjusted to a background, a plurality of auto-focus measurement regions (one small window and one large window) are generally defined. This method performs coarse scanning and fine scanning by using different areas from each other.

However, when the peak of an object and the peak of a background do not coincide with each other, second scanning can be required in the fine scanning. Further, when a scene present in the small window is nearly flat, sufficient contrast is not included therein. Therefore, the fine scanning cannot be performed reliably.

### SUMMARY OF THE INVENTION

An advantage of the present invention is that it provides an auto-focusing method and an auto-focusing apparatus using the same, which can perform auto-focusing within a short time through a small number of steps and solve such a problem that focus is adjusted to a background scene.

Additional aspect and advantages of the present general inventive concept will be set forth in part in the description which follows and, in part, will be obvious from the description, or may be learned by practice of the general inventive concept.

According to an aspect of the invention, an auto-focusing method comprises setting a plurality of active windows composed of a central window and a plurality of peripheral windows surrounding the central window and allocating weights to the plurality of peripheral windows so as to calculate an auto-focus value for each step; calculating a rate of change in auto-focus value between a previous step and a current step from the auto-focus value calculated for each step; comparing the calculated rate of change in auto-focus value with preset auto-focus reference values and then changing a step size in accordance with the comparison result; transferring a lens to a position corresponding to the changed step size; repeating the above processes from the setting of the plurality of active windows to the transferring of the lens until the auto-focus value of the previous step becomes larger than that of the current step and then determining whether the maximum auto-focus value is detected or not; and transferring the lens to a position corresponding to the maximum auto-focus value.

According to another aspect of the invention, in the transferring of the lens to the position corresponding to the maximum auto-focus value, the maximum auto-focus value is set to correspond to the auto-focus value of the previous step, and the lens is transferred to a position corresponding to the auto-focus value of the previous step.

According to a further aspect of the invention, the auto-focusing method further comprises determining whether or not the lens is transferred to a position corresponding to the maximum auto-focus value, in the transferring of the lens to the position corresponding to the maximum auto-focus value.

According to a still further aspect of the invention, the calculating of the rate of change in auto-focus value between the previous step and the current step is performed by the following equation:

$$slope ( rate of change ) = \frac{{AF}_{cur} - {AF}_{prev}}{step size} .$$

According to a still further aspect of the invention, the preset auto-focus reference values are two threshold values different from each other. Further, in the comparing of the calculated rate of change, the calculated rate of change in auto-focus value and the threshold values are compared, so that a step size is selected as any one of a fine step size, a medium step size, and a coarse step size in accordance with the comparison result.

According to a still further aspect of the invention, the comparing of the calculated rate of change further includes determining whether the auto-focus value passes by the peak or not, when the rate of change in auto-focus value between the previous step and the current step has a negative value.

According to a still further aspect of the invention, when the lens is transferred, the position of the transferred lens is detected and stored.

According to a still further aspect of the invention, the central window among the plurality of active windows are composed of a plurality of divided regions (windows).

According to a still further aspect of the invention, weights are allocated to all the regions corresponding to the plurality of central windows, and a weight is allocated to at least one of the plurality of peripheral windows.

According to a still further aspect of the invention, the weights allocated to the active windows are set to differ from each other.

According to a still further aspect of the invention, an auto-focusing apparatus comprises a lens section on which an optical signal is incident, the lens section having a focus lens which is capable of moving vertically; an image sensor and ISP section receiving the optical signal incident on the lens section so as to convert into an electrical signal and then outputting digitalized image data; an auto-focusing digital signal processing section including: an optical detection module receiving the image data from the image sensor and ISP section so as to extract predetermined image components, setting a plurality of active windows composed of a central window and a plurality of peripheral windows surrounding the central window, and allocating weights to the plurality of active windows such that the predetermined image components are integrated to calculate an auto-focus value; anda CPU receiving the auto-focus value from the optical detection module and calculating the maximum auto-focus value while vertically driving the focus lens of the lens section in accordance with the auto-focus value, the CPU performing an auto-focusing algorithm in which a rate of change in auto-focus value between a previous step and a current step is calculated and then is compared with preset auto-focus reference values such that a step size is controlled to change in accordance with the comparison result; and a driving section driving the focus lens of the lens section in accordance with a control signal of the auto-focusing digital signal processing section.

According to a still further aspect of the invention, the optical detection module includes a high-pass filter receiving image data from the image sensor and ISP section so as to extract predetermined image components; an integrator receiving the predetermined image components extracted from the high-pass filter and integrating and outputting the image components with respect to the respective active windows composed of the central window and the peripheral windows; and an active region setting section transmitting the start and end addresses of the plurality of active windows to the integrator.

According to a still further aspect of the invention, the auto-focusing apparatus further comprises a position detecting sensor for determining whether or not the lens is transferred to a position corresponding to the maximum auto-focus value.

According to a still further aspect of the invention, the predetermined image component is any one of an edge component, a Y-component, and a Y-component with the maximum value.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1A is a diagram illustrating a window within a picture;

FIG. 1B is a graph showing a focus value in accordance with a lens moving distance;

FIG. 2 is a graph for explaining the problems of an auto-focusing method according to the related art;

FIG. 3 is a block diagram illustrating an auto-focusing apparatus according to the present invention;

FIG. 4A is a diagram illustrating an auto-focusing digital signal processing section of FIG. 3;

FIG. 4B is an internal block diagram of an optical detection module of FIG. 4A;

FIG. 5 is a flow chart of an auto-focusing algorithm according to the invention;

FIG. 6 is a flow chart showing a process of calculating an auto-focus value in FIG. 5;

FIG. 7 is a diagram illustrating a plurality of active windows to which weights are allocated for the calculation of an auto-focus value;

FIG. 8 is a flow chart showing a process of adjusting a step size in FIG. 5;

FIG. 9 is a diagram showing a typical focus searching process according to the invention;

FIG. 10 is a diagram illustrating eight active windows to be applied to an embodiment of the invention;

FIG. 11 is a diagram showing changes in auto-focus value of the respective active windows for each lens position;

FIG. 12 is a diagram showing a change in overall auto-focus value for each step; and

FIG. 13 is a graph showing an operational example of an auto-focusing algorithm according to the embodiment of the invention.

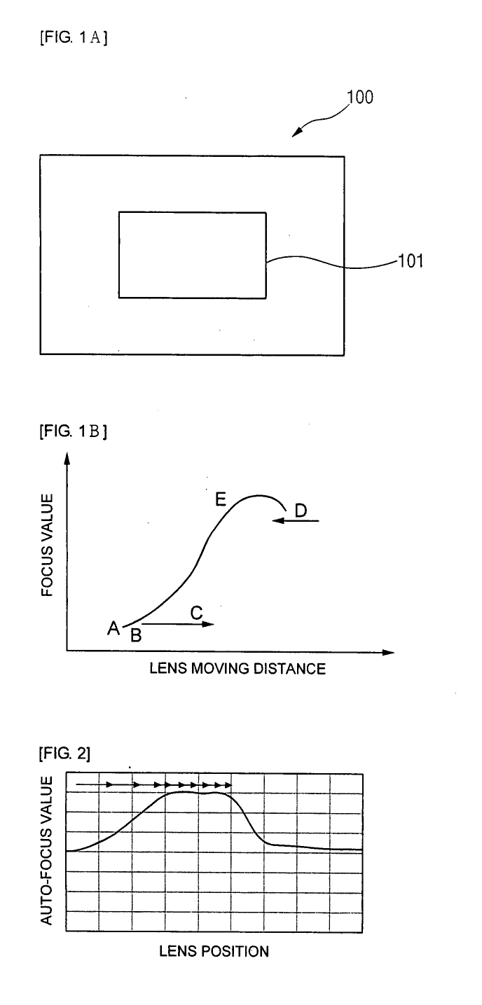

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

Hereinafter, embodiments of the present invention will be described in detail with reference to the accompanying drawings.

Auto-Focusing Apparatus

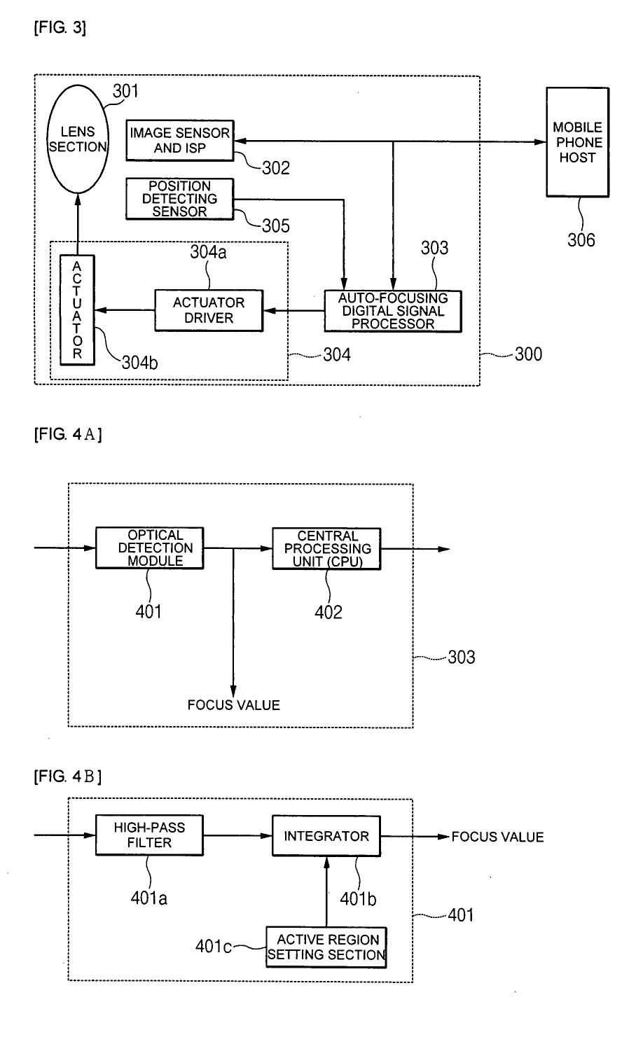

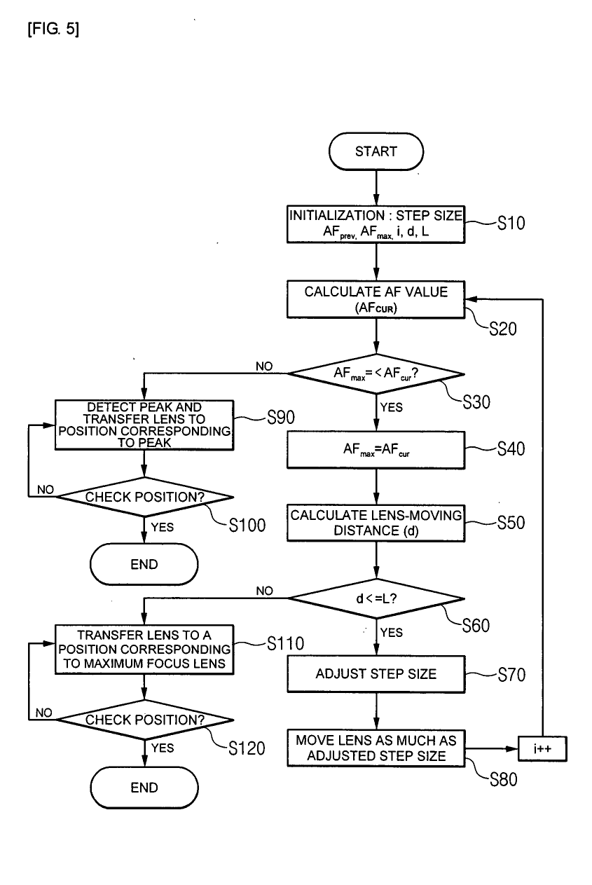

FIG. 3 is a block diagram illustrating an auto-focusing apparatus according to the present invention. FIG. 4A is a diagram illustrating an auto-focusing digital signal processing section of FIG. 3, and FIG. 4B is an internal block diagram of an optical detection module which is used in the auto-focusing digital signal processing section of FIG. 4A.

As shown in FIG. 3, the auto-focusing apparatus 300 according to the invention includes a lens section 301 on which an optical signal is incident, the lens section 301 having a focus lens which can move vertically for focus adjustment; an image sensor and ISP section 302 which receives an optical signal incident on the lens section 301 to convert into an electrical signal and then outputs digitalized image data; an auto-focusing digital signal processing section 303 which receives the image data from the image sensor and ISP section 302 and then performs an auto-focusing algorithm so as to calculate the maximum auto-focus value; and a driving section 304 composed of an actuator 304b, which drives a focus lens of the lens section 301, and an actuator driver 304a.

The lens section 301 is composed of a zoom lens and a focus lens. The zoom lens serves to enlarge an image, and the focus lens serves to adjust focus of an image. In accordance with an algorithm for an auto-focusing method according to the invention, the focus lens is vertically moved so that the lens position for optimal focusing is determined.

The image sensor and ISP section 302 is composed of an image sensor and an ISP (image signal processor). As for the image sensor, a CCD image sensor or CMOS image sensor can be used which converts an optical signal into an electrical signal. In order to reduce an auto-focusing time, the CMOS image sensor is preferably used.

In order to convert image data such that the image data is fitted to the sense of sight, the ISP performs signal processing tasks such as auto while balancing, auto exposure, gamma correction and the like so as to improve an image quality and then outputs image data with an enhanced image quality.

Since there are various types of CCD image sensors or CMOS image sensors, interfaces and characteristics for ISP are different from each other, depending on each maker. Therefore, the ISP is manufactured in accordance with the type of an image sensor.

The ISP performs image processing tasks such as color filter array interpolation, color matrix, color correction, color enhancement and the like.

In the case of a mobile terminal, image-processed data is converted into CCIR656 or CCIR601 format (YUV space), and a mobile phone host 306 receives a master clock signal so as to output Y/Cb/Cr or R/G/B data as well as a vertical synchronization signal, a horizontal synchronization signal, and a pixel clock signal.

As shown in FIG. 4B, the auto-focusing digital signal processor (auto-focusing DSP) 303 includes an optical detection module 401 which calculates an auto-focus value and a CPU 402 which receives the auto-focus value from the optical detection module 401 and performs an auto-focus algorithm for calculating the maximum auto-focus value while vertically driving the focus lens of the lens section in accordance with the auto-focus value.

The optical detection module 401 according to the invention receives image data from the image sensor and ISP section 302 so as to extract predetermined image components. Then, the optical detection module 401 sets a plurality of active windows composed of a central window and plural peripheral windows surrounding the central window, allocates different weights to the central window and the peripheral windows, respectively, and integrates the predetermined image components so as to calculate an auto-focus value.

The optical detection module 401 includes a high-pass filter 401a which receives image data from the image sensor and ISP section 302 so as to extract predetermined image components, an integrator 401b which receives the image components extracted from the high-pass filter 401a and then integrates and outputs the image components with respect to the plurality of active windows composed of the central window and the peripheral windows, respectively, and an active region setting section 401c which transmits the start and end addresses of the plurality of active windows which are set in the integrator 410b.

When the image data transmitted from the image sensor and ISP section 302 is input to the auto-focusing digital signal processing section 303 and is then passed through the high-pass filter 401a, only predetermined components of the image are extracted. The predetermined components to be extracted are an edge component, a Y-component, and a Y-component with the maximum value.

When the start and end positions of an active region within a picture are transmitted by the active region setting section 401c, the values of the components extracted by the high-pass filter 401a are accumulated by the integrator 401b. The accumulated values serve as reference data for adjusting focus in a camera module.

A method of calculating an auto-focusing value to which weight is granted will be described below.

In the case of a still image, focus is adjusted by moving the lens section 301. When the image is in complete focus, the focus value is high. When the image is not in focus, the focus value is low. Accordingly, in order to obtain the maximum focus value, a position of which the focus value is the greatest should be found while the lens 304 is moved by the actuator 304b through the actuator driver 304a.

The algorithm of finding a focus value is performed by the CPU 402. The CPU 402 determines which direction to move the lens section 30 and controls the driver 304 composed of the actuator driver 304a and the actuator 304b. The driving section further includes a position detecting sensor 305 for determining whether the lens is transferred to a position corresponding to the maximum focus value or not. Whenever the lens is transferred, the position detecting sensor 305 stores the position of the transferred lens as data.

The CPU 402 receives an auto-focus value from the optical detection module 401 and calculates the maximum auto-focus value while vertically moving the focus lens of the lens section in accordance with the auto-focus value. At this time, the CPU 402 calculates a rate of change in auto-focus value between a previous step and a current step and then compares the calculated rate of change in auto-focus value with the preset auto-focus reference value such that a step size is controlled in accordance with the comparison result.

Such an auto-focusing algorithm by the CPU 402 will be described below.

Auto-Focusing Algorithm

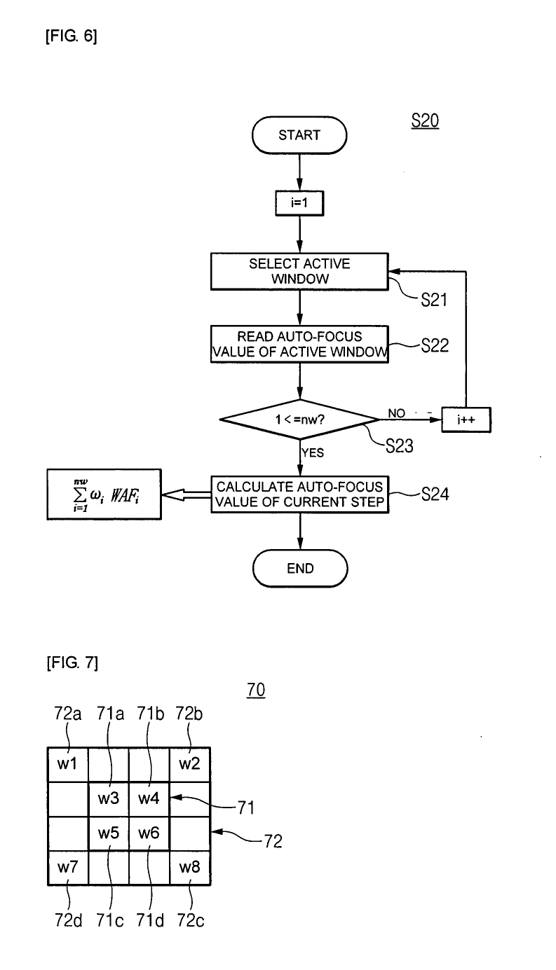

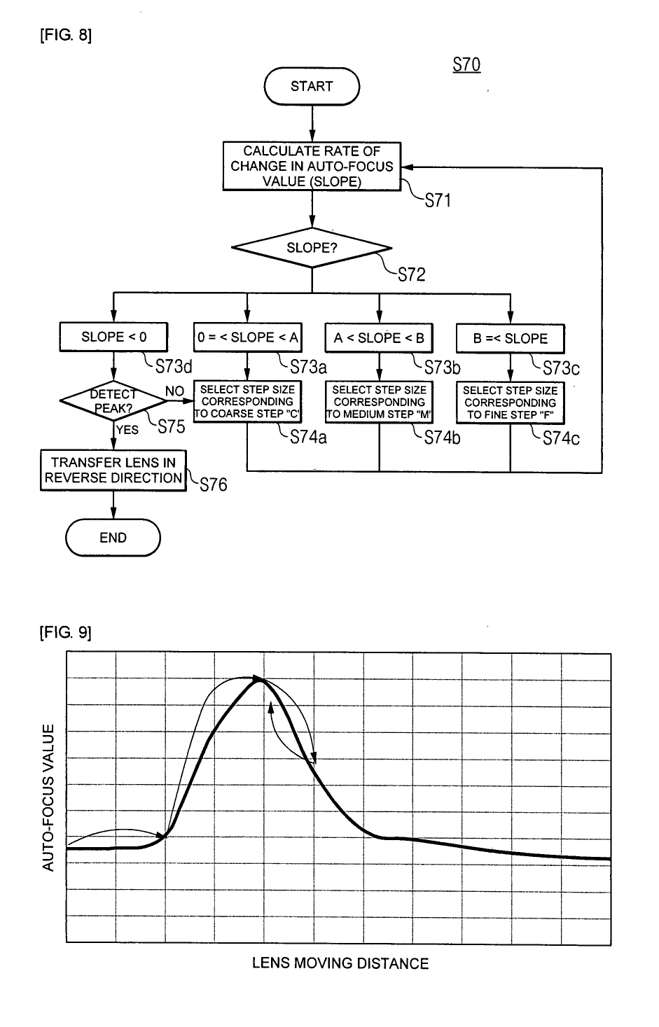

FIG. 5 is a flow chart of an auto-focusing algorithm according to the invention. FIG. 6 is a flow chart showing a process of calculating an auto-focus value in FIG. 5. FIG. 7 is a diagram illustrating a plurality of active windows 70 to which weights are allocated for the calculation of an auto-focus value. FIG. 8 is a flow chart showing a process of adjusting a step size in FIG. 5.

As shown in FIG. 5, the auto-focusing algorithm according to the invention will be performed in the following manner. In FIG. 5, reference numeral AFₚᵣₑᵥ represents an auto-focus value of a previous step, reference numeral AF_{cur} represents an auto-focus value of a current step, reference numeral AFₘₐₓ represents the maximum auto-focus value, reference numeral d represents a lens position from the initial state, reference numeral L represents the entire lens-transfer range, and i represents a counter which is allocated to an auto-focus active window.

First, a step size, AFₚᵣₑᵥ, AF_{cur}, AFₘₐₓ, d, L, and i are initialized (S10).

Next, the auto-focus value AF_{cur} which is an auto-focus value of a current step is calculated by the above initialized variables (S20). The auto-focus value AF_{cur} is calculated through the flow chart (S21 to S24) shown in FIG. 6, and the plurality of active windows 70 for calculating the auto-focus value AF_{cur} are illustrated in FIG. 7.

As shown in FIG. 7, the active window 70 according to the invention is composed of a central window 71 serving as a focus target and a plurality of peripheral windows 72 surrounding the central window 71.

As shown in FIG. 6, the central window 71 and the peripheral windows 72 are selected (S21). Then, auto-focus values are read with respect to the respective active windows (S22), and weight ωᵢ is allocated as in Expression 1 such that auto-focus values for each step with respect to the overall active windows are calculated (S23). In FIG. 6, reference numeral nw represents the total number of auto-focusing active windows, WAFᵢ represents an auto-focus value of an i-th active window, and ωᵢ represents a weight allocated to i-th active window.

$${\sum }_{i = 1}^{nw} {ω}_{i} {WAF}_{i} \qquad [ Expression 1 ]$$

Preferably, the central window 71 of the plurality of active windows 70 is divided into a plurality of regions (that is, the central window 71 is composed of a plurality of windows). Further, it is more preferable that weights are allocated to the regions corresponding to the plurality of central windows 71 and a weight is allocated to at least one of the plurality of peripheral regions 72.

This serves to solve such a problem that focus is adjusted to a background sight in the related art. In such a construction, focus can be adjusted to a desired object through single scan by the plurality of active windows 70 to which weight are allocated. Further, even when sufficient edge components are not present in the central window 71 even though weights are allocated, the plurality of peripheral windows 72 help to search a focus position.

Next, it is determined which one of the auto-focus value AF_{cur} of the current step and the maximum auto-focus value AFₘₐₓ is larger than the other, the auto-focus value AF_{cur} being calculated by the method shown in FIG. 6 (S30). When the auto-focus value AF_{cur} calculated in the current step is larger than the maximum auto-focus value AFₘₐₓ, the auto-focus value AF_{cur} is updated into the maximum auto-focus value AFₘₐₓ and is then stored (S40). On the other hand, when the auto-focus value AF_{cur} calculated in the current step is smaller than the maximum auto-focus value AFₘₐₓ, it is determined that the auto-focus value has passed by the peak (maximum value) in a lens-transfer curve (S90). The lens section is transferred backward to a position corresponding to the peak, and the position of the lens is then checked (S100). Preferably, the optimal focus position is recorded as a value from the position detecting sensor. Therefore, it is possible to solve a backlash problem in correcting overshoot.

After that, an accumulated lens-moving distance d corresponding to the auto-focus value AF_{cur} calculated in the current step is calculated (S50), and is then compared with the entire lens-transfer range L (S60). If the distance d is larger than the entire lens-transfer range L, the lens is transferred to a position corresponding to the maximum auto-focus value among the previously calculated values (S110), and the position of the lens is checked (S120). On the other hand, if the distance d is smaller than the entire lens-transfer range L, a step size is adjusted for the lens transfer (S70).

For the adjustment of step size (S70) and the movement as much as the adjusted step size (S80) as shown in FIG. 8, a rate of change in auto-focus value, that is, a slope should be calculated by Expression 2 in consideration of an auto-focus value AFₚᵣₑᵥ of a previous step and an auto-focus value AF_{cur} of a current step (S71 and S72).

$$slope ( rate of change ) = \frac{{AF}_{cur} - {AF}_{prev}}{step size} \qquad [ Expression 2 ]$$

The step size can be represented by Expression 3.

Step size=step(# of step)×constant displacement [Expression 3]

In Expression 3, the constant displacement and the number of steps with respect to a coarse step, a medium step, and a fine step can be designated arbitrarily.

In FIG. 8, threshold values A and B correspond to a reference value for allocating a proper step size in accordance with the calculated slope. The slope and the threshold values A and B are compared with each other (S73), and a proper step size is allocated depending on the comparison results (S74).

That is, when the calculated slope is smaller than the threshold value A (S73a), the lens is transferred as much as a step size corresponding to the coarse step “C” (S74a). When the calculated slope is larger than the threshold value A and is smaller than the threshold value B (S73b), the lens is transferred as much as a step size corresponding to the medium step “M” (S74b). When the calculated slope is larger than the threshold value B (S73c), the lens is transferred as much as a step size corresponding to the fine step “F” (S74c). Meanwhile, if the calculated slope has a negative value (S73d), it is checked whether the peak is detected or not (S75). Then, if the peak is not detected, the lens is transferred as much as a step size corresponding to the coarse step “C”. If the peak is detected, the lens is transferred to the reverse direction (S76).

The above-described processes S20 to S80 are repeatedly performed until the auto-focus value of a previous step becomes larger than that of a current step. That is, when the lens is moved as much as a predetermined size of step, and if the maximum auto-focus value AFₘₐₓ is larger than the auto-focus value AV_{cur,} the algorithm according to the invention determines that the peak is detected. In this case, the slope does not need to be calculated any more.

Finally, the lens is reversely transferred to a position (peak) corresponding to the maximum auto-focus value, and the auto-focusing is completed (S90 and S100). The maximum auto-focus value is set to correspond to the auto-focus value of the previous step, and the lens can be transferred to a position corresponding to the auto-focus value of the previous step. Further, as described above, the position of the lens from the position detecting sensor is continuously stored. Therefore, the lens can be transferred by using positional data corresponding to the maximum auto-focus value among the data on the stored position values. When the position detecting sensor is used, it is possible to solve a backlash problem in correcting overshoot.

FIG. 9 is a diagram showing a typical focus searching process according to the invention. First, two large steps are taken. Then, a step size is reduced in accordance with a sudden change in slope. The lens is transferred backward as much as the reduced step size so as to return to the position corresponding to the peak.

### Embodiment

Hereinafter, an embodiment of the auto-focusing method according to the invention will be described with reference to the accompanying drawings.

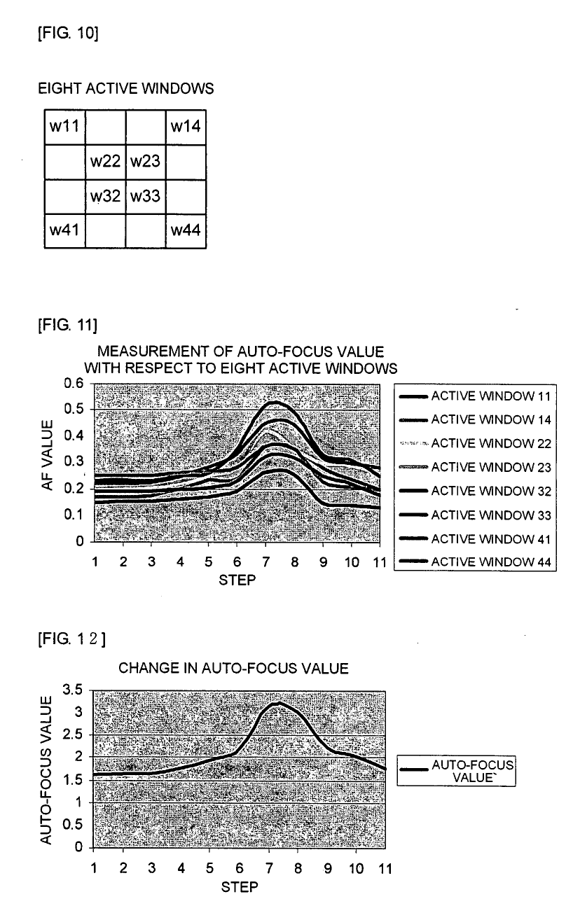

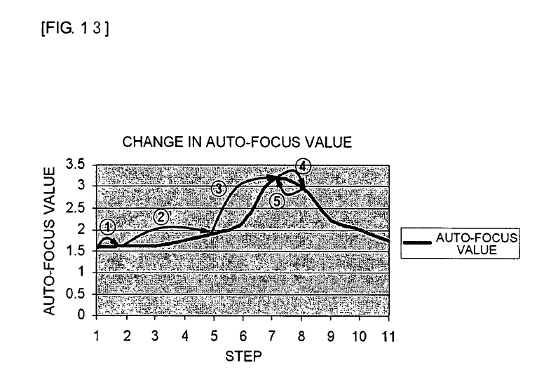

FIG. 10 is a diagram illustrating eight active windows to be applied to the embodiment of the invention. FIG. 11 is a diagram showing changes in auto-focus value of the respective active windows for each lens position. FIG. 12 is a diagram showing a change in overall auto-focus value for each step. FIG. 13 is a graph showing an operational example of an auto-focusing algorithm according to the embodiment of the invention.

FIG. 10 shows a plurality of active windows W11, W14, W22, W23, W32, W33, W41, and W44 which are applied to this embodiment. Auto-focus values are measured in the respective active windows. Table 1 shows results in which the auto-focus values are measured in the respective active windows with respect to a step corresponding to a lens position.

TABLE 1

| | Active | Active | Active | Active | Active | Active | Active | Active | Auto- |
|---|---|---|---|---|---|---|---|---|---|
| | window | window | window | window | window | window | window | window | focus |
| | 11 | 14 | 22 | 23 | 32 | 33 | 41 | 44 | value |
| Initial | 0.15 | 0.17 | 0.2 | 0.21 | 0.22 | 0.23 | 0.25 | 0.19 | 1.62 |
| position | | | | | | | | | |
| Step I | 0.152 | 0.172 | 0.202 | 0.212 | 0.222 | 0.232 | 0.252 | 0.192 | 1.636 |
| Step II | 0.155 | 0.175 | 0.205 | 0.215 | 0.225 | 0.23 | 0.25 | 0.19 | 1.645 |
| Step III | 0.16 | 0.2 | 0.22 | 0.23 | 0.245 | 0.25 | 0.26 | 0.2 | 1.765 |
| Step IV | 0.18 | 0.235 | 0.25 | 0.27 | 0.30 | 0.26 | 0.27 | 0.205 | 1.97 |
| Step V | 0.19 | 0.24 | 0.28 | 0.285 | 0.33 | 0.35 | 0.28 | 0.23 | 2.185 |
| Step VI | 0.262 | 0.362 | 0.42 | 0.442 | 0.452 | 0.52 | 0.362 | 0.322 | 3.142 |
| Step VII | 0.255 | 0.355 | 0.355 | 0.44 | 0.445 | 0.495 | 0.355 | 0.32 | 3.02 |
| Step VIII | 0.15 | 0.28 | 0.3 | 0.38 | 0.32 | 0.33 | 0.23 | 0.25 | 2.24 |
| Step IV | 0.14 | 0.24 | 0.29 | 0.32 | 0.3 | 0.31 | 0.21 | 0.22 | 2.03 |
| Step X | 0.13 | 0.2 | 0.26 | 0.25 | 0.28 | 0.25 | 0.2 | 0.18 | 1.755 |

In Table 1, the column represents active windows for measuring auto-focus values, and the row represents lens positions measured in the active windows, that is, steps. The auto-focus values written in the last column mean the auto-focus values calculated by the flow chart shown in FIG. 6.

FIG. 11 is a diagram showing changes in auto-focus value at eight of the respective active windows for each lens position (step). FIG. 12 is a diagram showing a curve for searching the peak (the maximum auto-focus value). The curve shows a change in auto-focus value calculated by using the measurement in the active windows, corresponding to the last column of Table 1.

The auto-focus values corresponding to the last column of Table 1 are calculated by Expression 1 which has been described above. In this embodiment, an auto-focus value for each step can be expressed by Expression 4. In this embodiment, the same weight ω of “1” is allocated to all the active windows, and Wᵢⱼ in Expression 4 corresponds to an auto-focus value measured in a corresponding active window.

Auto-focus value=ω·W₁₁+ω·W₁₄+ω·W₂₂+ω·W₂₃+ω·W₃₂+ω·W₃₃+ω·W₄₁+ω·W₄₄ [Expression 4]

In the following Table 2, slopes corresponding to rates of change in auto-focus value calculated in the flow chart of FIG. 8 are described.

TABLE 2

| Step | Auto-focus value | $slope = \frac{{AF}_{cur} - {AF}_{prev}}{step size}$ |
|---|---|---|
| I | 1.62 | no calculation of slope |
| II | 1.636 | 0.016 |
| III | 1.645 | |
| IV | 1.765 | |
| V | 1.97 | 0.111 |
| VI | 2.185 | |
| VII | 3.142 | 0.586 |
| VIII | 3.02 | |
| IX | 2.24 | |
| X | 2.03 | |
| XI | 1.755 | |

After the initialization, the slope is not calculated for the first time, but a small step is selected.

At the second step (II), the auto-focus value (1.636) thereof is larger than that (1.62) of the first step. Therefore, the maximum auto-focus value AFₘₐₓ is updated into “1.636”, and the position value from the position detecting sensor is recorded.

As shown in FIG. 5, the next slope is calculated by using the auto-focus values at the first and second steps through Expression 5.

$$\frac{{AF}_{cur} - {AF}_{prev}}{step size} = \frac{{AF}_{II} - {AF}_{I}}{1} = 0.016 \qquad [ Expression 5 ]$$

Here, the step size can be represented by Expression 3 (Step size=step(# of step)×constant displacement).

In this embodiment, the constant displacement is defined as “1”, and the number of steps is defined as follows:

the number of steps with respect to the coarse step: three

the number of steps with respect to the medium step: two

the number of steps with respect to the fine step: one.

Meanwhile, the threshold values A and B corresponding to the reference values shown in FIG. 8 are defined as follows:

A=0.05 and B=0.15.

Since the slope calculated in Expression 5 is “0.016”, it is smaller than the threshold value A. Therefore, as shown in FIG. 8, a step size is selected as the coarse step “C”. Then, a new slope is calculated by the algorithm in consideration of “step size=3”, as in Expression 6.

$$\frac{{AF}_{cur} - {AF}_{prev}}{step size} = \frac{{AF}_{V} - {AF}_{II}}{3} = 0.111 \qquad [ Expression 6 ]$$

Since the new auto-focus value is larger than the previous auto-focus value, the maximum AFₘₐₓ and the lens position with respect to the maximum auto-focus value AFₘₐₓ are updated into new values. Further, since the calculated slope corresponds to a value between the threshold values A and B, the step size is selected as the medium step “M”. Similarly, a new slope is calculated by the algorithm in consideration of “step size=2”, as in Expression 7.

$$\frac{{AF}_{cur} - {AF}_{prev}}{step size} = \frac{{AF}_{VII} - {AF}_{V}}{2} = 0.586 \qquad [ Expression 7 ]$$

After the auto-focus value approaches a value larger than the auto-focus value of the previous step, the slope is calculated in order to adjust the next step size. Since the slope calculated by Expression 7 is larger than the threshold value B, the step size is selected as the fine step “M”. Similarly, a new slope is calculated by the algorithm in consideration of “step size=1”.

However, when the lens is further transferred by one step, “AFₘₐₓ>AF_{cur}” is detected. Then, the algorithm detects the peak. Therefore, the slope does not need to be calculated any more.

After the peak is detected, the lens is transferred backward until it approaches a position corresponding to the maximum auto-focus value. Preferably, since the optimal focus position is recorded as a value from the position detecting sensor, it is possible to solve a backlash problem in correcting overshoot.

FIG. 13 is a diagram showing an operational example of the auto-focusing algorithm according to this embodiment. As shown in FIG. 13, an auto-focus value can approach the maximum auto-focus value through only the five steps \textcircled{1}to \textcircled{5}in the auto-focusing algorithm according to this embodiment. The last step \textcircled{5}corresponds to the backward transfer. In this case, focus measurement is not performed. Further, the backward transfer is preferably performed by using an output value from the position detecting sensor, as described above.

According to the auto-focusing method and the auto-focusing apparatus using the same, the auto-focusing is performed within a short time through a smaller number of steps such that an auto-focusing time can be reduced.

Recently, more and more CMOS image sensors having an enhanced image quality and low power consumption are used in mobile phones, smart phones, and PDAs. In the invention, it is possible to solve such a problem that an auto-focusing time is lengthened due to a low frame rate of the CMOS image sensor.

Further, in order to calculate the auto-focus value, the plurality of active windows are set, to which weights are allocated. Therefore, it is possible to solve such a problem that focus is adjusted to a background sight.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An auto-focusing method comprising:
setting a plurality of active windows composed of a central window and a plurality of peripheral windows surrounding the central window and allocating weights to the plurality of active windows so as to calculate an auto-focus value for each step;
calculating a rate of change in auto-focus value between a previous step and a current step from the auto-focus value calculated for each step;
comparing the calculated rate of change in auto-focus value with preset auto-focus reference values and then changing a step size in accordance with the comparison result;
transferring a lens to a position corresponding to the changed step size;
repeating the above processes from the setting of the plurality of active windows to the transferring of the lens until the auto-focus value of the previous step becomes larger than that of the current step and then determining whether the maximum auto-focus value is detected or not; and
transferring the lens to a position corresponding to the maximum auto-focus value.

2. The auto-focusing method according to claim 1,
wherein in the transferring of the lens to the position corresponding to the maximum auto-focus value, the maximum auto-focus value is set to correspond to the auto-focus value of the previous step, and the lens is transferred to a position corresponding to the auto-focus value of the previous step.

3. The auto-focusing method according to claim 1 further comprising
determining whether or not the lens is transferred to a position corresponding to the maximum auto-focus value, in the transferring of the lens to the position corresponding to the maximum auto-focus value.

4. The auto-focusing method according to claim 1,
wherein the calculating of the rate of change in auto-focus value between the previous step and the current step is performed by the following equation:
$$slope ( rate of change ) = \frac{{AF}_{cur} - {AF}_{prev}}{step size} .$$

5. The auto-focusing method according to claim 4,
wherein the preset auto-focus reference values are two threshold values different from each other.

6. The auto-focusing method according to claim 5,
wherein in the comparing of the calculated rate of change, the calculated rate of change in auto-focus value and the threshold values are compared, so that a step size is selected as any one of a fine step size, a medium step size, and a coarse step size in accordance with the comparison result.

7. The auto-focusing method according to claim 4,
wherein the comparing of the calculated rate of change further includes determining whether the auto-focus value passes by the peak or not, when the rate of change in auto-focus value between the previous step and the current step has a negative value.

8. The auto-focusing method according to claim 1,
wherein when the lens is transferred, the position of the transferred lens is detected and stored.

9. The auto-focusing method according to claim 1,
wherein the central window among the plurality of active windows are composed of a plurality of divided regions (windows).

10. The auto-focusing method according to claim 9,
wherein weights are allocated to all the regions corresponding to the plurality of central windows, and a weight is allocated to at least one of the plurality of peripheral windows.

11. The auto-focusing method according to claim 1,
wherein the weights allocated to the active windows are set to differ from each other.

12. An auto-focusing apparatus comprising:
a lens section on which an optical signal is incident, the lens section having a focus lens which is capable of moving vertically;
an image sensor and ISP section receiving the optical signal incident on the lens section so as to convert into an electrical signal and then outputting digitalized image data;
an auto-focusing digital signal processing section including:
an optical detection module receiving the image data from the image sensor and ISP section so as to extract predetermined image components, setting a plurality of active windows composed of a central window and a plurality of peripheral windows surrounding the central window, and allocating weights to the plurality of active windows such that the predetermined image components are integrated to calculate an auto-focus value; and
a CPU receiving the auto-focus value from the optical detection module and calculating the maximum auto-focus value while vertically driving the focus lens of the lens section in accordance with the auto-focus value, the CPU performing an auto-focusing algorithm in which a rate of change in auto-focus value between a previous step and a current step is calculated and then is compared with preset auto-focus reference values such that a step size is controlled to change in accordance with the comparison result; and
a driving section driving the focus lens of the lens section in accordance with a control signal of the auto-focusing digital signal processing section.

13. The auto-focusing apparatus according to claim 12,
wherein the optical detection module includes:
a high-pass filter receiving image data from the image sensor and ISP section so as to extract predetermined image components;
an integrator receiving the predetermined image components extracted from the high-pass filter and integrating and outputting the image components with respect to the respective active windows composed of the central window and the peripheral windows; and
an active region setting section transmitting the start and end addresses of the plurality of active windows to the integrator.

14. The auto-focusing apparatus according to claim 12 further comprising
a position detecting sensor for determining whether or not the lens is transferred to a position corresponding to the maximum auto-focus value.

15. The auto-focusing apparatus according to claim 12,
wherein the predetermined image component is any one of an edge component, a Y-component, and a Y-component with the maximum value.
